(19) United States
(12) Patent Application Publication
(10) Pub. No.: US 2026/0346654 A1
(43) Pub. Date: Nov. 5, 2026

(54) OPTIMIZED ARCHITECTURE OF A CIVIL ENGINEERING-TYPE TIRE

(71) Applicant: COMPAGNIE GENERALE DES ETABLISSEMENTS MICHELIN, Clermont-Ferrand (FR)

(72) Inventors: WILLIAM LICENSE, Clermont-Ferrand (FR); FRANCOIS BARBARIN, Clermont-Ferrand (FR)

(21) Appl. No.: 19/120,316

(22) PCT Filed: Oct. 5, 2023
(86) PCT No.: PCT/EP2023/077541

§ 371 Date: Apr. 11, 2025

(30) Foreign Application Priority Data
Oct. 13, 2022 (FR) FR2210512

(51) Int. Cl. B60C 15/024; B60C 15/06

(52) U.S. Cl. CPC B60C 15/024; B60C 2015/0621; B60C 2200/065

(57) ABSTRACT

A radial tire for a vehicle of the civil engineering type is intended to be mounted on a nominal rim (1), comprising a hook (122) having a circular part. The part of the external surface (31) of the bead is configured to be in contact with the nominal rim (1), as far as a point (311) of contact with the circular part of the rim hook, the angle (A1) between the radius of the circular part of the rim passing through the point of contact (311) and the axial direction being comprised between 80 and 85°.

The subject of the present invention is a radial tyre intended to be fitted to a heavy-duty vehicle of the civil engineering type, and the present invention relates more particularly to the bead and the sidewall of such a tyre.

Radial tyres intended to be fitted to a heavy-duty vehicle of the civil engineering type are designated within the meaning of the European Tyre and Rim Technical Organisation, or ETRTO, standard.

For example, a radial tyre for a heavy-duty vehicle of the civil engineering type, within the meaning of the European Tyre and Rim Technical Organisation, or ETRTO, standard, is intended to be mounted on a rim with a diameter at least equal to 25 inches. Although not limited to this type of application, the invention is described for a radial tyre of large size, which is intended to be mounted on a dumper, in particular on vehicles for transporting materials extracted from quarries or surface mines, by way of a rim with a diameter at least equal to 35 inches, possibly as much as 57 inches, or even 63 inches.

The tyres are intended to be mounted on rims the geometric specifics of which are given in the technical documentation of the national or international organizations such as the European Tyre and Rim Technical Organisation or ETRTO or the United States Tire and Rim Association, or TRA. Those documents specify what rim is to be used for what size of tyre, and for objects as technical as tyres for civil engineering vehicles, there is only one rim size that corresponds, to within the manufacturing tolerances, to one size of tyre.

Since a tyre and a rim have a geometry exhibiting symmetry of revolution about an axis of rotation which is the same axis once the tyre has been mounted on the rim, their geometries are generally described in a meridian plane containing the axis of rotation. For a given meridian plane, the radial, axial and circumferential directions denote the directions perpendicular to the axis of rotation of the tyre or of the rim, parallel to the axis of rotation, and perpendicular to the meridian plane, respectively. The circumferential direction is tangential to the circumference of the tyre.

In the following text, the expressions “radially inner/radially to the inside” and “radially outer/radially to the outside” mean “closer to the axis of rotation of the tyre/rim” and “further away from the axis of rotation of the tyre/rim”, respectively. The expressions “axially inner/axially to the inside” and “axially outer/axially to the outside” mean “closer to the equatorial plane of the tyre/rim” and “further away from the equatorial plane of the tyre/rim”, respectively. The equatorial plane or midplane of the tyre is the plane that passes through the middle of the tread surface and is perpendicular to the axis of rotation. Likewise, the equatorial plane or midplane of the rim is the plane that passes through the middle of the two rim hooks and is perpendicular to the axis of rotation.

Generally, a tyre comprises a tread intended to come into contact with the ground by means of a tread surface, the two axial ends of which are connected by means of two sidewalls to two beads that provide the mechanical connection between the tyre and the rim on which it is intended to be mounted.

A radial tyre also comprises a reinforcement made up of a crown reinforcement radially to the inside of the tread and of a carcass reinforcement radially to the inside of the crown reinforcement.

The carcass reinforcement of a radial tyre for a heavy-duty vehicle of the civil engineering type usually comprises a carcass layer comprising generally metal reinforcers, or reinforcing elements, that are coated in a polymeric material of the elastomer or elastomeric type obtained by blending and known as a coating compound. A carcass layer comprises a main part, joining the two beads together and generally wrapped, in each bead, from the inside to the outside of the tyre around a usually metal circumferential reinforcing element known as a bead wire so as to form a turnup. The metal reinforcers of a carcass layer are substantially parallel to one another and form an angle of between 80° and 100° with the circumferential direction. The diameters of the reinforcing elements of the carcass layers have, in the case of civil engineering tyres, a diameter at least equal to 1.5 mm.

In civil engineering, the carcass reinforcement of the prior art (see U.S. Pat. No. 5,236,031) comprises a single carcass layer with no other layer of reinforcing elements. The end of the turnup is close to the axially outermost point of the tyre, or even lies radially to the outside thereof, as disclosed in the cited document. If this end is positioned too close to the bead wire, there is a risk that, under the effect of pressure and heat during intensive usage, the reinforcing elements of the carcass layer may slip under the bead wire, resulting in a sudden loss of tyre pressure. If the end of the turnup is situated in an intermediate radial position such that its radial distance to the radially innermost point of the tyre is less than twice the height of the hook of the nominal rim, the end of the turnup will be in a compression zone, thereby increasing the risk of cracking of the rubber compositions surrounding these ends. Positioning the end of the turnup near the axially outermost point of the tyre makes it possible to prevent the ends of the reinforcing elements from being responsible for causing the onset of cracking. However, the turnup is subjected, in the flexing zone, to tension-compression cycles that may lead to fatigue rupture of the reinforcing elements. The prior art (see U.S. Pat. No. 5,236,031) proposes bringing the turnup closer to the main part of the carcass layer in order to reduce the bending stresses since the bead behaves like a beam. However, that solution is complicated by the diameter of the reinforcing elements used in the carcass layers of tyres for civil engineering vehicles. Given their bending stiffness, it is difficult to keep them, throughout the manufacturing process, in the position that is ideal for the endurance of the tyre.

Nevertheless, this solution is unable to solve all of the problems with the endurance of the bead and of the carcass layer at the periphery thereof. Specifically, on the uneven ground on which the tyres of civil engineering vehicles are used, the ever-increasing speed of the vehicles, in order to increase their productivity, creates phenomena of resonance as the tyre separates from the ground, followed by bouncing, which implies extremely great dynamic overloads which may be as much as 2 times the nominal load. On top of this phenomenon there are the practices that are detrimental to the endurance of the bead, such as use with pressures lower than those recommended, or load increased beyond the nominal load. Reducing the pressure is a tactic employed to improve the endurance of the crown with respect to impact loading, but this is accompanied by an increase in the deformation of the carcass layer above the bead. Moreover, the electrification of the power units will also, on account of the weight of the batteries, lead to a need to improve the overload endurance of the beads.

The inventors have set themselves the objective, for a radial tyre for a vehicle of the civil engineering type, of increasing the endurance of the bead.

This objective has been achieved, according to the invention, by a tyre for a vehicle of the civil engineering type, intended to be mounted on a nominal rim, said nominal rim comprising, on each side of a midplane perpendicular to the axis of rotation of said rim, a tapered rim seat and a flange, of radial height G, formed axially from the inside towards the outside of a radial first part and of a hook formed by a circular first part of standardized radius R1 and of centre O1, and of a hook tip, the tyre comprising:
a crown reinforcement, radially to the inside of a tread, said tread being connected by means of two sidewalls to two beads,
each bead having an external surface extended by an external surface of the sidewall,
a radial carcass reinforcement extending between the two beads and comprising at least one carcass layer comprising metal reinforcers which, with the circumferential direction, make an angle of between 80° and 100° and are coated in a rubber composition, said carcass layer being anchored in each of the beads by a turnup around a bead wire to form a main part extending from one bead wire to the other, and a turnup, axially to the outside of the main part in each of the beads and having a free end,
the external surface of the bead being configured in each meridian plane to be in contact with said nominal rim, the measurement being taken on a tyre mounted and inflated to the nominal pressure on said nominal rim, on the seat and the flange of the rim as far as a last point of contact with the circular part of the nominal rim hook, the last point of contact being the radially outermost point of contact between the nominal rim and the bead, the angle between the radius of the circular part of the nominal rim passing through said last point of contact and the axial direction being comprised between 80 and 85°.

The invention consists in a civil engineering radial tyre comprising a metal carcass layer of which the bead is configured to have an enlarged area of contact with the rim hook so as to maximize the reaction of the compressive stresses by the rubber compositions in order to relieve the stress on the reinforcing elements of the turnup and of the main part of the carcass layer. The last point of contact between the rim and the bead needs to be correctly positioned so that the gain in endurance of the carcass layer is not destroyed by the failure of the rubber compositions in the bead which compositions are more heavily loaded in the invention than they are in the prior art. This pressure loading alters the deformation in this region of the bead.

What is meant by the external surface of the tyre is the surface that delineates the object. This surface may be radially exterior, in which case it designates the tread surface. It may be axially exterior, in which case it is the surface, of the sidewalls or of the bead, that is intended to be in contact with the rim. It may be interior, in which case it is intended, once the tyre has been mounted on its rim, to be in contact with an inflating gas.

Thus, the current sizing of the axially exterior external surface of the beads of civil engineering tyres is such that, in the mounted and inflated position, contact reaches approximately to the middle of the circular part of the rim hook, this being the most reliable method for having mechanical continuity between the bead and the sidewall. The upper part of the rim hook then serves to accompany the sidewall in its deformation when the tyre is compressed in the case of that part of the tyre that is situated in the vicinity of the contact patch. This solution is all the more advantageous when the carcass reinforcement comprises a single carcass layer.

In the invention, the rim hook reacts some of the compressive load leading to a better distribution of the loads of contact between the bead and the rim. For that, it is important for the last point of contact between the rim hook and the external surface of the bead to be in a specific position relative to the rim hook, namely the angle (A1) between the radius of the circular part of the rim passing through the last point of contact and the axial direction needs to be comprised between 80 and 85°. Up to this angle, the operation of the bead remains the same, and upwards of this angle the continuity of connection of the bead to the sidewall implies a suboptimal geometry for the tyre. The angle (A1) between the radius of the circular part of the rim passing through the last point of contact and the axial direction is determined from the point of intersection of the rim with the axial axis as far as the last point of contact between the rim hook and the external surface of the bead.

The position of the last point of contact with respect to the rim hook can be determined by any relevant measurement means using a feeler for example or using optical or contact profilometry. These measurement methods will also make it possible to determine the values of the other characteristics of the external surface of the tyre described in the present invention.

In order to avoid concentrating stress in the region where the sidewall meets the bead, a preferred solution is, once the tyre has been mounted and inflated on the nominal rim, that on the axially exterior parts of the bead and of the sidewall, the external surface of the bead should be connected to the external surface of the sidewall by a radially innermost part of the external surface of the sidewall, said radially innermost part being substantially circular over a portion of a radial height at least equal to 0.2 times R1 and at most equal to 0.4 times R1, the radius of the rim hook, the centre of curvature of said radially innermost part of the external surface of the sidewall being axially to the inside of said radially innermost part of the external surface of the sidewall. The curvature of said radially innermost part of the external surface of the sidewall thus dimensioned and positioned with a centre of curvature positioned towards the plane of symmetry of the tyre with respect to the external surface makes it possible to avoid there being a significant discontinuity on the external surface of the sidewall or the need to dimension a sidewall that is thicker than necessary. What is meant by substantially circular is that, in each meridian plane, between the last point of contact and a point on the external surface that is situated radially between 0.2 times and 0.4 times R1, the external surface lies on a curve comprised between two circles with radii varying by 10%.

One preferred solution for optimizing the stresses where the sidewall meets the bead is, with the tyre mounted and inflated on the nominal rim, for the radially innermost part of the external surface of the sidewall to be substantially circular in shape, following a circle of which the centre lies on the straight line passing through the centre of the circular part of the hook of said rim and the last point of contact, and of which the radius R2 is comprised between 0.25 and 0.4 times the radius R1 of the circular part of the hook of said rim.

One advantageous solution for ensuring the best continuity of the external surface of the sidewall notably between the radially innermost circular part and the part adjacent to that is, with the tyre mounted and inflated on the nominal rim, for the radially innermost part of the external surface of the sidewall to be substantially circular in shape over an angular portion comprised between 65° and 75° and measured from the radius formed by the last point of contact and the centre of the circle.

In order to optimize the shape of the sidewall and notably the thermal behaviour thereof, with the tyre mounted and inflated on the nominal rim, the external surface of the sidewall radially to the outside of and adjacent to the substantially circular radially innermost part of the external surface of the sidewall over a radial height equal to the radial height G of the hook of the nominal rim, has a centre of curvature axially to the outside of the bead, and preferably a mean radius of curvature at least equal to 400 mm. In tyres according to the prior art, the centre of curvature of this region of the sidewall is axially to the inside of the bead in the continuation of the connection between the bead and the sidewall. The invention requires the entirety of that region to be reconfigured in order to make it work properly.

This reconfiguration of the bead and of the adjacent part of the sidewall has the effect of shifting the point of compression of the carcass layer turnup towards a point that is radially outward compared with the solution of the prior art. This point is located, with respect to the axially outermost point of the rim seat, at between 2 and 2.5 times the height G of the rim hook. In order to minimize the compression in the turnup at this point, the turnup therefore needs to be brought closer to the main part of the carcass layer. Compared with the solution of the prior art, this convergence at this point is far easier to achieve because there is a greater length of turnup available with which to achieve this convergence. One preferred solution is therefore, when the tyre is mounted and inflated on the nominal rim, for the distance between the main part of the carcass layer and its turnup to be minimal at a radial height from the axially outermost point of the seat of the nominal rim which height is comprised between 2 and 2.5 times the height G of the hook of the nominal rim.

The distance between the main part of the carcass layer and its turnup may be measured on a meridian cross section. The distance is measured from the neutral axis of the carcass layer as far as the neutral axis of the turnup perpendicular to the neutral axis of the main part of the carcass layer.

For good distribution of stiffness within the bead, it is advantageous for the distance between the main part of the carcass layer and its turnup to decrease continuously from the geometric centre of the bead wire as far as the point at which said distance is at its minimum.

For optimal operation of the bead and of the sidewall, it is advantageous for a single rubber composition, referred to as a bead filler, to fill the volume between the main part of the carcass layer and its turnup, this rubber composition having a secant tensile modulus MA10 at 10% strain, measured at 23 °C in accordance with the standard ASTM D 412, at least equal to 5 MPa.

To avoid excessive deformation gradients between the bead filler and the rubber composition with which the reinforcing elements of the carcass layer are coated, it is advantageous for a single rubber composition to fill the volume between the main part of the carcass layer and its turnup, and to have a secant tensile modulus MA10 at 10% strain, measured at 23 °C in accordance with the standard ASTM D 412, at least equal to 90% and preferably at most equal to 110% of the same modulus of the rubber composition coating the reinforcing elements of the carcass layer.

Likewise, for optimal operation of the sidewall in bending, it is preferable for a rubber composition adjacent to and axially to the outside of the turnup of the carcass layer, the composition being arranged at least radially to the outside of said last point of contact of the external surface of the bead, to have a secant tensile modulus MA10 at 10% strain, measured at 23 °C in accordance with the standard ASTM D 412, at least equal to 90% and preferably at most equal to 110% of the tensile modulus MA10 of the bead filler.

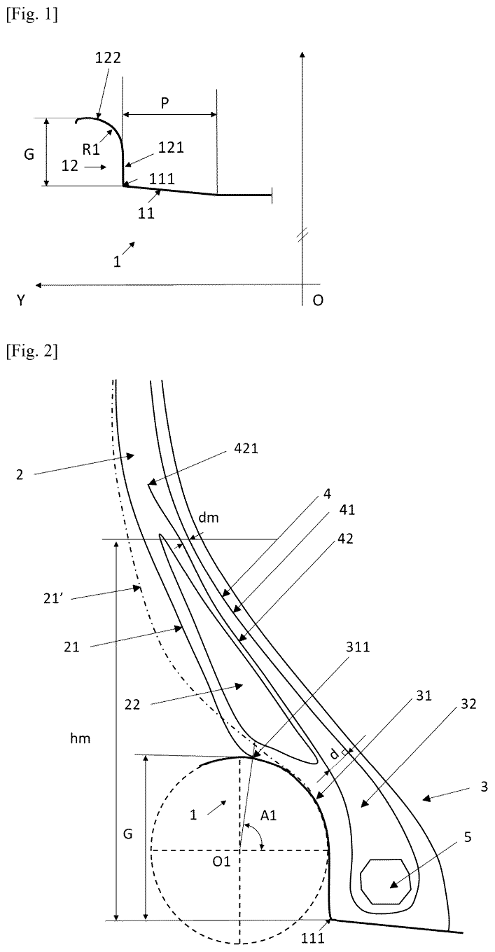

The features of the invention are illustrated in the schematic FIGS. 1 to 3, which are not to scale, with reference to a tyre of size 24.00 R35.

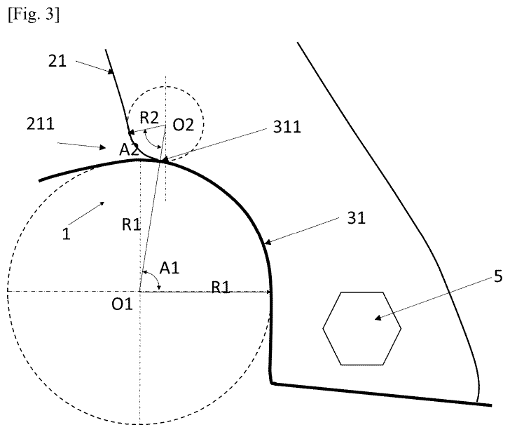

FIG. 1 depicts the outline of a tapered-seat rim (1) for tyres of size 25, 29, 33, 35, 49, 51, 57 and 63 inches as set out in the “Tire and Rim Association” documentation. This outline represents a cross section through a rim comprising, on each side of a midplane perpendicular to the axis of rotation (OY) of said rim, a tapered rim seat (11) and a flange (12), of radial height G, formed axially from the inside towards the outside of a radial first part (121) and of a hook (122) formed by a circular first part of standardized radius R1 and of centre O1 (see FIGS. 2 and 3), and of a hook tip. The figure also shows the axially outermost point (111) of the rim seat (11) on the surface for contact with the tyre. In instances in which the seat (11) of the nominal rim is attached to the flange (12) by a fillet radius, the fillet radius would be considered as being the start of the flange (12).

FIG. 2 shows details of a meridian section through a tyre for a heavy-duty vehicle of the civil engineering type mounted and inflated on its rim (1), and notably shows the sidewall (2) and the bead (3). The bead (3) has an external surface (31) extended by an external surface of the sidewall (21). The radial carcass reinforcement comprises a carcass layer (4) anchored in the bead by a turnup around a bead wire (5) to form a main part (41) extending from one bead wire to the other, and a turnup (42), axially to the outside of the main part (41) in each of the beads (3) and having a free end (421). The external surface (31) of the bead is configured to be in contact with the nominal rim (1) as far as the radially outermost point of contact (311) on the circular part, of centre (O1), of the rim hook, the angle (A1) between the radius of the circular part of the rim passing through said last point of contact (311) and the axial direction being comprised between 80 and 85°. According to FIGS. 2 and 3, the angle (A1) between the radius of the circular part of the rim passing through the last point of contact and the axial direction is determined from a point of intersection of the rim with the axial axis as far as the last point of contact between the rim hook and the external surface of the bead. FIG. 2 also shows the distance (d) between the main part (41) of the carcass layer (4) and its turnup (42), which distance decreases continuously as far as its minimum (dm) which lies at a radial height hm from the axially outermost point of the seat (111) of the rim, which height hm is comprised between 2 and 2.5 times the height G of the hook of the rim. A single rubber composition, referred to as a bead filler (32), fills the volume between the main part (41) of the carcass layer (4) and its turnup (42), adjacent to and axially to the inside of a rubber composition (22). FIG. 2 also shows the profile (21′) of a tyre according to the prior art.

FIG. 3 is an enlarged detail view of the bead to show the transition between the bead and the sidewall around the last point of contact (311) between the external surface (31) of the bead (3) and the nominal rim (1). The external surface (21) of the sidewall (2) is, in its radially innermost part (211), substantially circular in shape, following a circle of which the centre (O2) lies on the straight line passing through the centre (O1) of the circular part of the hook (122) and the last point of contact (311), and of which the radius R2 is comprised between 0.25 and 0.4 times the radius R1 of the circular part of the hook (122) of said rim (1), over an angular portion (A2) comprised between 65° and 75° and measured from the radius formed by the last point of contact (311) and the centre (O2) of the circle.

The invention was tested on tyres of size 24.00 R35. The tyres according to the invention are compared against reference tyres of the same size.

The reference tyres and the tyres according to the invention have a single carcass layer of which the metal reinforcers are cords of 7 strands comprising 7 steel threads of 23 hundredths of 2.24 mm in diameter and laid at a pitch of 2.6 mm under the bead wire. The turnups for the two tyres have their free ends (421) in the vicinity of the axially outermost point of the tyre. The rubber compositions used are equivalent for both solutions. The geometry of the external surface of the bead has been modified so that the last point of contact (311) passes, in the case of the control tyre, at an angle A1 close to 60° and, in the case of the tyre according to the invention, at an angle equal to 81.3°. In the case of the control tyre, the meeting at the point of contact is in the form of a curve that is substantially circular over the entire part of the sidewall comprised between the last point of contact (311) and the axially outermost point of the tyre, the centre of curvature of which curve is axially to the inside of the bead. In the case of the tyre according to the invention, the bead meets the sidewall at a circular portion extending over an angular portion of 69°, the centre of this angular portion lying on the straight line extending the radius of the circular part of the rim hook passing through the last point of contact (311) between the external surface (31) of the bead (3) and the rim (1). The radius of this circular part is equal to 0.3 times the radius R1 of the circular part of the rim (1). The distance (d) between the main part (41) of the carcass layer (4) and its turnup (42) is minimal at a radial height hm from the axially outermost point of the seat (111) of the rim, which height hm is equal to 2.1 times the height G of the rim hook in the case of the invention, as opposed to 1.0 times the height G in the case of the reference tyre.

The other components of the control tyres and of the tyres according to the invention, the crown architecture, the rubber compounds, etc. are identical.

The tyres were tested on a machine. They were first of all planed down to the bottom of the tread pattern so as to concentrate the stress loadings in the sidewalls and the beads. The profile of the tread of the tyre planed-down corresponding to the profile of the tread when new. Two tyres were compressed against one another with a force of 25 000 daN corresponding to the nominal load plus 25% of overload at 6.2 bar of pressure, namely a pressure 1.05 bar lower than the nominal pressure. The tyres were run against one another at a speed of 15 km/h. The tyre according to the invention sustained over 1000 h of running without damage while the tyre according to the prior art was stopped after 600 h upon breakage of the rubber compounds in the sidewall, in the part adjacent to the rim hook.

Thus, the invention does indeed lead to an at least 66% improvement to the endurance performance of the sidewall and of the bead when used overloaded and underinflated.

1.-10. (canceled)

11. A tire for a civil engineering vehicle, intended to be mounted on a nominal rim, the nominal rim comprising, on each side of a midplane perpendicular to a rotation axis of the nominal rim, a rim seat that is tapered and a flange that has a radial height G and is formed axially from inside to outside by a radial first part and a hook, the hook being formed axially from inside to outside by a circular part, having a standardized radius R1 and a center O1, and by a hook tip, the tire comprising:
a tread connected to two beads of the tire respectively by two sidewalls of the tire, each bead having an external surface extended by an external surface of the sidewall;
a crown reinforcement, radially inside the tread; and
a radial carcass reinforcement, extending between the two beads and comprising at least one carcass layer comprising metal reinforcers which, with a circumferential direction of the tire, make an angle of between 80° and 100° and are coated in a coating rubber composition, the at least one carcass layer being anchored in each bead by turning around a wire of the bead so that the at least one carcass layer forms a main part, extending from the wire of one of the beads to the wire of the other bead, and a turnup, axially outside the main part in each bead and having a free end,
wherein the external surface of the bead is configured, when the tire is mounted and inflated to a nominal pressure on the nominal rim, to be in contact in each meridian plane of the tire with the nominal rim on the rim seat and the flange as far as a last contact point that is in contact with the circular part of the hook, the last contact point being a radially outermost point of contact between the nominal rim and the bead, and
wherein an angle between a radius of the circular part passing through the last contact point and an axial direction of the tire is comprised between 80 and 85°.

12. The tire according to claim 11, wherein, on an axially outer part of the bead and an axially outer part of the sidewall, the external surface of the bead is connected to the external surface of the sidewall by a radially innermost part of the external surface of the sidewall, the radially innermost part:
being substantially circular over a portion having a radial height at least equal to 0.2 times R1 and at most equal to 0.4 times R1, and
having a curvature center axially inside the radially innermost part.

13. The tire according to claim 12, wherein the radially innermost part of the external surface of the sidewall is substantially circular in shape, following a circle having:
a center that lies on a straight line passing through a center of the circular part of the hook and the last contact point, and
a radius R2 that is comprised between 0.25 and 0.4 times R1.

14. The tire according to claim 13, wherein the radially innermost part of the external surface of the sidewall is substantially circular in shape over an angular portion comprised between 65° and 75° and measured from a radius of the circle passing through the last contact point.

15. The tire according to claim 11, wherein the external surface of the sidewall has a part that:
is radially outside and adjacent to a radially innermost part of the external surface of the sidewall,
extends over a radial height that is equal to the radial height G, and
has a curvature center that is axially outside the bead.

16. The tire according to claim 11, wherein a distance between the main part and the turnup of the at least one carcass layer is minimal at a radial height from an axially outermost point of the rim seat, the radial height hm being comprised between 2 and 2.5 times the radial height G.

17. The tire according to claim 11, wherein a distance between the main part and the turnup of the at least one carcass layer decreases continuously from a geometric center of the wire of the bead as far as a point at which the distance is at a minimum.

18. The tire according to claim 11, wherein a single rubber bead filler composition fills a volume between the main part and the turnup of the at least one carcass layer and has a secant tensile modulus MA10 at 10% strain, measured at 23 °C in accordance with the standard ASTM D 412, at least equal to 5 MPa.

19. The tire according to claim 11, wherein a single rubber bead filler composition fills a volume between the main part and the turnup of the at least one carcass layer and has a secant tensile modulus MA10 at 10% strain, measured at 23 °C in accordance with the standard ASTM D 412, at least equal to 90% of a secant tensile modulus of the coating rubber composition.

20. The tire according to claim 18, wherein a rubber composition adjacent to and axially outside the turnup of the at least one carcass layer is arranged at least radially outside the last contact point and has a secant tensile modulus MA10 at 10% strain, measured at 23 °C in accordance with the standard ASTM D 412, at least equal to 90% of the tensile modulus MA10 of the single rubber bead filler composition.

21. The tire according to claim 19, wherein a rubber composition adjacent to and axially outside the turnup of the at least one carcass layer is arranged at least radially outside the last contact point and has a secant tensile modulus MA10 at 10% strain, measured at 23 °C in accordance with the standard ASTM D 412, at least equal to 90% of the tensile modulus MA10 of the single rubber bead filler composition.
